(19) United States
(12) Patent Application Publication
(10) Pub. No.: US 2008/0229029 A1
(43) Pub. Date: Sep. 18, 2008

(54) Semiconductor Memory System Having Plurality of Ranks Incorporated Therein

(75) Inventor: Shin-Deok Kang, Gyeonggi-do (KR)

Correspondence Address: BAKER & MCKENZIE LLP;PATENT DEPARTMENT, 2001 ROSS AVENUE, SUITE 2300, DALLAS, TX, 75201, US

(73) Assignee: HYNIX SEMINCONDUCTOR, INC., Ichon (KR)

(21) Appl. No.: 11/958,302

(22) Filed: Dec. 17, 2007

(30) Foreign Application Priority Data
Mar. 13, 2007 (KR) 10-2007-0024444

(51) Int. Cl. G06F 12/00

(52) U.S. Cl. 711/149; 711/147; 711/E12.001

(57) ABSTRACT

A semiconductor memory system which can integrate a plurality of ranks without occupying an increased area. The semiconductor memory system includes a memory device that has a plurality of ranks each having banks integrated therein, and a shared circuit section that is integrated in the memory device and is shared by the plurality of ranks. The plurality of ranks are selectively operated based on the signals provided from the shared circuit section.

### CROSS-REFERENCES TO RELATED APPLICATION

The present application claims priority under 35 U.S.C. 119(a) to Korean Patent Application number 10-2007-0024444, filed on Mar. 13, 2007, in the Korean Intellectual Property Office, the contents of which are incorporated herein by reference in their entirety as if set forth in full.

### BACKGROUND

1. Technical Field

The embodiments described herein relate to a semiconductor memory system, and more particularly, to a semiconductor memory system that includes a memory device having a plurality of ranks incorporated therein in a reduced footprint.

2. Related Art

A conventional memory system includes a memory controller and memory devices such as Dynamic Random Access Memory (DRAM) devices. In some systems, a processor performs the function of the memory controller. Such memory devices are generally located on memory modules. Modules are connected to the memory controller via a memory interface. The memory interface provides communication between the memory controller and the memory device. For example, the memory interface can include a chip select line, an address bus line, a command signal line, and a data bus line.

In such a memory system, the memory controller can be mounted on a mother board, or a printed circuit board, and the memory device, or devices can be mounted on the memory modules. The memory modules can then be connected to the mother board through connectors.

The memory device may be a memory array having a table of cells. These cells can include capacitors for holding charges and for storing at least one data bit depending upon the configuration of the memory device. When multiple memory devices are included, each of the memory devices is referred to as a rank in the mother board.

Referring to FIG. 1, a conventional semiconductor memory system 50 is configured in a manner such that two ranks 10a and 10b share a clock signal (CK), a clock enable signal (CKE), command signals (/RAS), (/CAS) and (/WE), and a data signal (DQ). Each of the ranks 10a and 10b can include an input buffer 12, a command decoder 14, a bank controller 16 and a plurality of memory banks (banks 0 to N) 18. The two ranks 10a and 10b are selected by respective chip select signals (/cs0) and (/cs1).

In the semiconductor memory system 50, if the commands signals (/RAS) (/RAS), (/CAS) and (/WE) are input to the ranks 10a and 10b, commands are generated in the command decoders 14 via the respective input buffers 12 in the ranks 10a and 10b. The commands generated in this way are input to the bank controllers 16 in the respective ranks 10a and 10b, and control signals for selecting banks are generated in the bank controllers 16.

In such a conventional semiconductor memory system 50 having a dual rank configuration, advantages are provided in that two ranks can share the command signals and the data signal.

In order to construct the semiconductor memory system having the dual rank configuration, the two memory devices can be integrated on the mother board. This will, however, increase the area requirements for the semiconductor memory system. Therefore, a problem exists in that it is difficult to apply the dual rank configuration to a current compact semiconductor memory system, where the memory devices are integrated on the mother board with the memory controller.

### SUMMARY OF THE INVENTION

A semiconductor memory system can integrate a plurality of ranks without occupying an increased area.

According to one aspect, there is provided a semiconductor memory system comprising a memory device having a plurality of ranks integrated therein. Each of the ranks can have banks, and a shared circuit section shared by the plurality ranks of the memory device, wherein the plurality of ranks are selectively operated by signals provided by the shared circuit section.

The memory device can receive a plurality of command signals and chip select signals for selecting the ranks. The shared circuit section can comprise an input buffer for receiving the plurality of command signals and the chip select signals and generating internal input signals and internal chip select signal, and a command decoder for receiving the internal input signals and the internal chip select signals output by the input buffer and for generating internal active signals for driving the ranks.

Each of the plurality of ranks can include a bank controller for outputting a control signal to at least one of the banks in response to the internal active signal output by the command decoder of the shared circuit section, wherein the banks comprise a plurality of memory cell arrays.

The command decoder can comprise a decoding circuit unit for receiving the internal input signals, and a selection circuit unit for generating the internal active signals to determine a rank to be operated in response to an output signal of the decoding circuit unit, the internal chip select signals and a rank mode signal.

The decoding circuit unit can include a logic circuit which outputs a high level when all the plurality of internal input signals have a high level.

The memory device can comprise two ranks, and the selection circuit unit can comprise a first internal signal generation part for receiving a first internal chip select signal for selecting a first rank of the two ranks and the output signal of the decoding circuit unit and generating a first active signal for driving at least one of the banks in the first rank, and a second internal signal generation part for receiving a second internal chip select signal for selecting a second rank of the two ranks, the rank mode signal and the output signal of the decoding circuit unit and generating a second active signal for driving at least one of the banks in the second rank.

The rank mode signal can be a signal that causes the two ranks to be selectively operated or to be simultaneously operated as one rank depending upon a phase of the rank mode signal.

According to another aspect, there is provided a semiconductor memory system comprising a memory device having a plurality of ranks integrated therein and each having banks, and a shared circuit section shared by the plurality of ranks. The shared circuit section can comprise an input buffer for receiving a plurality of command signals and chip select signals for selecting the ranks and generating internal input signals and internal chip select signals, and a command decoder for receiving the internal input signals and the internal chip select signals outputted from the input buffer and a rank mode signal and outputting internal active signals for driving the ranks.

These and other features, aspects, and embodiments are described below in the section entitled “Detailed Description.”

### BRIEF DESCRIPTION OF THE DRAWINGS

The above and other aspects, features and other advantages of the subject matter of the present disclosure will be more clearly understood from the following detailed description taken in conjunction with the accompanying drawings, in which:

FIG. 1 is a block diagram illustrating a conventional semiconductor memory system.

FIG. 2 is a block diagram illustrating a semiconductor memory system in accordance with an embodiment.

FIG. 3 is a block diagram illustrating a command decoder that can be included in the semiconductor memory system of FIG. 2.

FIG. 4 is a circuit diagram illustrating a decoding circuit unit that can be included in the command decoder of FIG. 3.

FIG. 5 is a detailed circuit diagram illustrating the command decoder if FIG. 3 according to one embodiment.

FIG. 6 is a timing diagram illustrating operation of the semiconductor memory system of FIG. 1.

FIG. 7 is a circuit diagram illustrating a variation of the decoding circuit unit according to the embodiment of the present invention.

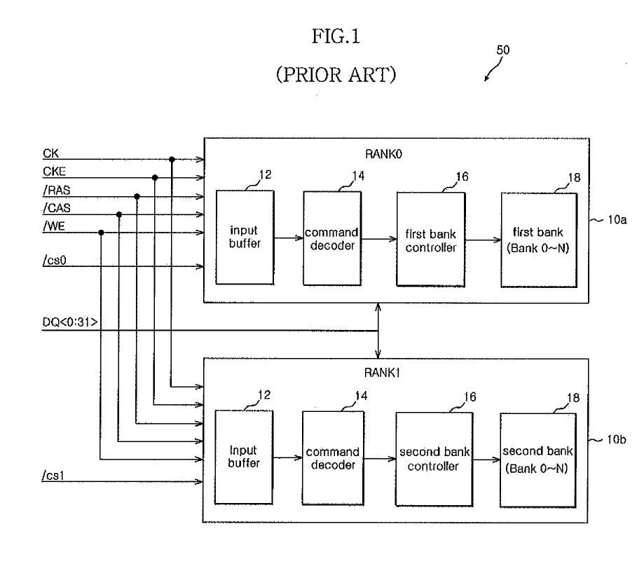

### DETAILED DESCRIPTION

The embodiments described herein provide a semiconductor memory system having a semiconductor memory device into which two ranks are incorporated in such a way as to occupy a compact area. The two ranks incorporated into one semiconductor memory device share an input buffer and a command decoder. Therefore, it is possible to reduce the area of the semiconductor memory device. Also, the semiconductor memory system can include a rank mode select signal such that a plurality of ranks, for example two ranks can be operated individually or simultaneously as one rank. Accordingly, it is possible to drive the plurality of ranks or a single rank.

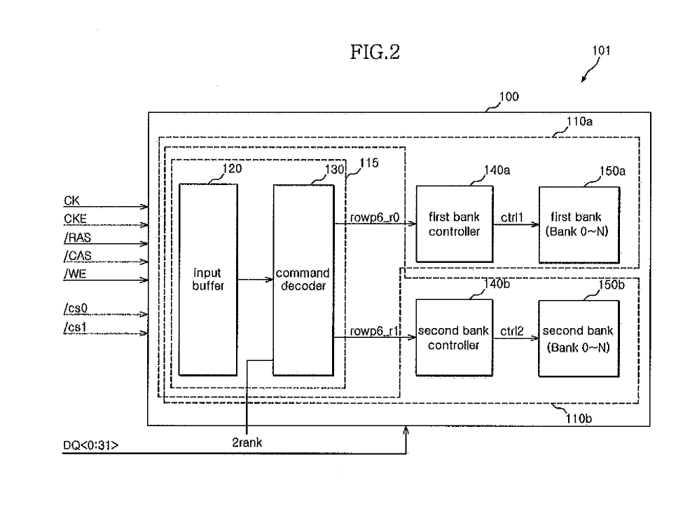

FIG. 2 is a diagram illustrating an example semiconductor memory system 101 according to one embodiment.

Referring to FIG. 2, it can be seen that the semiconductor memory system 101 can include one semiconductor memory device 100 into which a plurality of ranks, for example, two ranks 110a and 110b are incorporated. Each of the ranks 110a and 110b can include a shared circuit section 115, a bank controller 140a and 140b, and banks 150a and 150b.

The shared circuit section 115 can be composed of an input buffer 120 and a command decoder 130. The shared circuit section 115 can be coupled with the first and second bank controllers 140a and 140b and the first and second banks 150a and 150b to constitute the ranks 110a and 110b. The memory device 100 can be driven by receiving a clock signal (CK), a clock enable signal (CKE), command signals (/RAS), (/CAS) and (/WE), chip select signals (/cs0) and (/cs1), and a DQ signal (DQ<0:31>).

The input buffer 120 can be configured to receive the command signals (/RAS), (/CAS) and (/WE) and the chip select signals (/cs0) and (/cs1) from outside of the memory device 100, and generate internal input signals (irasb), (icas) and (iwe) and internal chip select signals (ics0b) and (ics1b) using the command signals (/RAS), (/CAS) and (/WE) and the chip select signals (/cs0) and (/cs1).

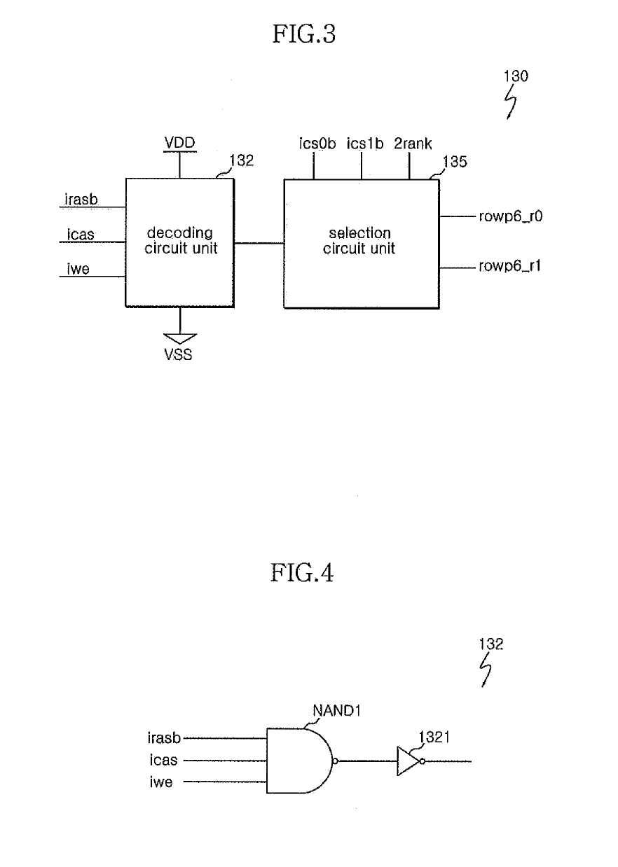

The command decoder 130 can be configured to receive the internal input signals (irasb), (icas) and (iwe) and the internal chip select signals (ics0b) and (ics1b) from the input buffer 120, and to generate internal active signals (rowp6_r0) and (rowp6_r1). Referring to FIG. 3, the command decoder 130 can include a decoding circuit unit 132 and a selection circuit unit 135 depending on the embodiment. The decoding circuit unit 132 can be configured to receive and decode the internal input signals (irasb), (icas) and (iwe). The selection circuit unit 135 can be configured to receive the output signal of the decoding circuit unit 135, the internal chip select signals (ics0b) and (ics1b) and a rank mode signal (2rank) and to generate internal active signals for selecting the ranks. The rank mode signal (2rank) can be a signal provided externally.

The decoding circuit unit 132 can be designed to output a high level when all the internal input signals (irasb), (icas) and (iwe) have a high level. For example, as shown in FIG. 4, the decoding circuit unit 132 can include a 3-input NAND gate NAND1 configured to receive the internal input signals (irasb), (icas) and (iwe), and an inverter 1321 configured to invert the output signal from the NAND gate NAND1.

FIG. 5 is a circuit diagram illustrating the command decoder 130 of FIG. 3 in more detail. Referring to FIG. 5, it can be seen that the NAND gate NAND1 can include a first PMOS transistor P1, a second PMOS transistor P2, a first NMOS transistor N1, a second NMOS transistor N2, and a third NMOS transistor N3. These transistors are connected with one another in a manner such that the first and second PMOS transistors P1 and P2 are connected in parallel and the first through third NMOS transistors N1, N2 and N3 are connected in series.

The first PMOS transistor P1 has a gate that receives the internal input signal (irasb), a source connected with a source voltage VDD, and a drain which is connected with the first NMOS transistor N1. The first NMOS transistor N1 has a gate that receives the internal input signal (icas), a drain connected with the drain of the first PMOS transistor P1, and a source connected with the second NMOS transistor N2. The second NMOS transistor N2 has a gate that receives the internal input signal (iwe), a drain connected with the source of the first NMOS transistor N1, and a source connected with the third NMOS transistor N3. The third NMOS transistor N3 has a gate that receives the internal input signal (irasb), a source connected with the source of the second NMOS transistor N2, and a drain connected with a ground voltage VSS.

The first inverter 1321 can be configured to invert the output signal of the NAND gate NAND1. The second PMOS transistor P2 has a gate that then receives the output signal of the first inverter 1321, a source connected with the source voltage VDD, and a drain connected with the drain of the first PMOS transistor P1.

The selection circuit unit 135 can include a first internal signal generation part 135a that outputs an internal active signal for operating at least one of the banks 150a in the first rank 110a, and a second internal signal generation part 135b that outputs an internal active signal for operating at least one of the banks 150b in the second rank 110b.

The first internal signal generation part 135a can include an amplification section 136, a first logic combining section 138, and a second inverter 140. The amplification section 136 amplifies the first internal chip select signal (ics0b) for selecting the first rank 110a. The amplification section 136 can be composed of a third and a fourth inverters 1361 and 1362 connected in series. The first logic combining section 138 can include a NAND gate that receives the output signal of the decoding circuit unit 132 and the output signal of the amplification section 136 and then executes a NANDing operation. The second inverter 140 inverts and amplifies the output signal of the first logic combining section 138 and outputs the first internal active signal (rowp6_r0) for operating at least one of the banks 150a in the first rank 110a.

The second internal signal generation part 135b can include a fifth inverter 142, a second logic combining section 144, and a third logic combing section 146, and a sixth inverter 148. The fifth inverter 142 inverts the second internal chip select signal (ics1b) for selecting the second rank 110b. The second logic combining section 144 can include a NAND gate that receives the inverted second internal chip select signal (ics1b) and a rank mode signal (2rank) and then executes a NAND operation. The rank mode signal (2rank) can be a signal for selecting the first rank 110a and/or the second rank 110b, which are integrated in one memory device 100. The rank mode signal (2rank) can be a Mode Register Set (MRS) signal that allows the two ranks 110a and 110b to be selectively operated when the rank mode signal (2rank) has a high level and to be simultaneously operated when the rank mode signal (2rank) has a low level.

The third logic combining section 146 is a NAND gate that receives the output signal of the second logic combining section 144 and the output signal of the decoding circuit unit 132 and then executes a NAND operation. The sixth inverter 148 inverts and amplifies the output signal of the third logic combining section 146 and outputs the second internal active signal (rowp6_r1).

The first and second bank controllers 140a and 140b respectively can be configured to receive the first internal active signal (rowp6_r0) and the second internal active signal (rowp6_r1) and then respectively output first and second control signals ctrl1 and ctrl2 for driving the first and second banks 150a and 150b. The first and second control signals ctrl1 and ctrl2 are respectively input to the first and second banks 150a and 150b and selectively or simultaneously operate the memory cell arrays that constitute the banks 150a and 150b.

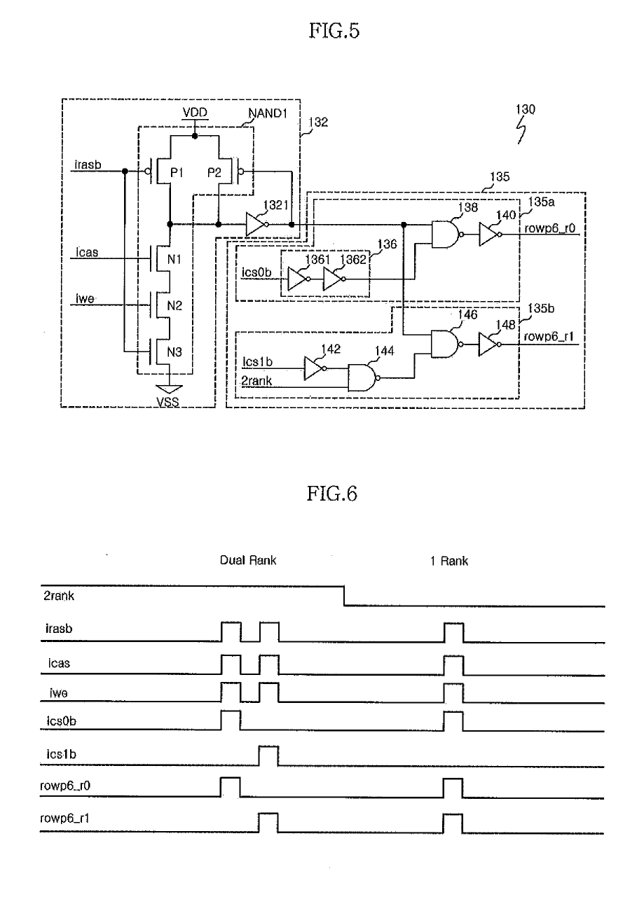

The operation of the semiconductor memory system 101 configured as mentioned above will be described below in detail with reference to FIGS. 5 and 6.

First, the command signals (/RAS), (/CAS) and (/WE) and the chip select signals (/cs0) and (/cs1) can be input to one memory device 100 in which two ranks, sharing the input buffer and the command decoder, are integrated. The command signals (/RAS), (/CAS) and (/WE) and the chip select signals (/cs0) and (/cs1) can be input to an input buffer 120 in the memory device 100, can become the internal input signals (irasb), (icas) and (iwe) and the internal chip select signals (ics0b) and (ics1b) as described above.

The internal input signals (irasb), (icas) and (iwe) and the internal chip select signals (ics0b) and (ics1b), which are generated in the common input buffer 120, can then be input to the command decoder 130, where the internal active signals (rowp6_r0) and (rowp6_r1) for selectively or simultaneously driving the dual bank are generated.

In further detail, when the rank mode signal (2rank) is enabled as a high signal and all the internal input signals (irasb), (icas) and (iwe) are enabled as high signals, the decoding circuit unit 132, included in the common command decoder 130, can output a high level by turning off the first PMOS transistor P1 and turning on the first through third NMOS transistors N1, N2 and N3. At this time, if the first internal chip select signal (ics0b) for driving the first banks 150a is enabled as a high signal, the first internal signal generation part 135a outputs the internal active signal (rowp6_r0) at a high state and drives the first bank controller 140a.

Also, if the second internal chip select signal (ics1b) for driving the second banks 150b is enabled, instead of the first internal chip select signal (ics0b), then the second internal signal generation part 135b will output the internal active signal (rowp_r1) at a high level and drive the second bank controller 140b. In other words, the first internal chip select signal (ics0b) and the second internal chip select signal (ics1b) can be selectively enabled.

Meanwhile, in a state in which the rank mode signal (2rank) is enabled as a low signal, if the internal input signals (irasb), (icas) and (iwe) and the first internal chip select signal (ics0b) are enabled at a high level, irrespective of whether the second internal chip select signal (ics1b) is enabled or not, the first and second internal active signals (rowp6_r0) and (rowp6_r1) simultaneously go to a high level. Accordingly, one memory device 100 can execute operations as if it includes one rank.

As will be apparent from the above description, since two ranks integrated in one memory device can share an input buffer and a command decoder, the area requirements of a semiconductor memory system can be significantly reduced. Also, depending upon whether a rank mode select signal is enabled or not, the semiconductor memory system can selectively operate in a dual rank configuration or in a single rank configuration, whereby it is possible to realize various operation modes.

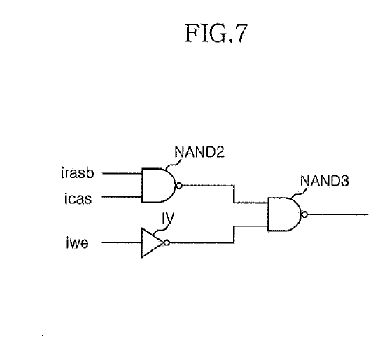

While the decoding circuit unit 132 was described in the above embodiment as including a combination of the 3-input NAND gate NAND1 and the inverter 1321, it will be understood that the decoding circuits 130 is not necessarily limited to such an implementation. For example, a circuit comprising a first NAND gate NAND2 for receiving internal input signals (irasb) and (icas), an inverter IV for inverting an internal input signal (iwe), and a second NAND gate NAND3 for NANDing output signals of the first NAND gate NAND2 and the inverter IV as shown in FIG. 7, can be used as the decoding circuit unit 132. In general, the embodiments described herein can be implemented using various circuits as long as the circuits chosen can generate the required signals as described herein.

Also, while an example of integrating two ranks was described in the above embodiment, it is to be readily understood that the embodiments described herein are not necessarily so limited.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A semiconductor memory system comprising:
a memory device having a plurality of ranks integrated therein; and
a shared circuit section shared by the plurality ranks of the memory device,
wherein the plurality of ranks are selectively operated by signals provided by the shared circuit section.

2. The semiconductor memory system according to claim 1, wherein the memory device is inputted with a plurality of command signals and chip select signals for selecting the ranks.

3. The semiconductor memory system according to claim 2, wherein the shared circuit section comprises:
an input buffer for receiving the plurality of command signals and the chip select signals to generate internal input signals and internal chip select signals; and
a command decoder for receiving the internal input signals and the internal chip select signals outputted from the input buffer to output internal active signals for driving the ranks.

4. The semiconductor memory system according to claim 1, wherein each of the plurality of ranks includes:
a plurality of banks; and
a bank controller for outputting a control signal to at least one of the banks in response to the internal active signal outputted from the command decoder of the shared circuit section,
wherein the banks comprise a plurality of memory cell arrays.

5. The semiconductor memory system according to claim 3, wherein the command decoder comprises:
a decoding circuit unit for receiving the internal input signals; and
a selection circuit unit for generating the internal active signals to determine a rank to be operated, in response to an output signal of the decoding circuit unit, the internal chip select signals and a rank mode signal.

6. The semiconductor memory system according to claim 5, wherein the decoding circuit unit includes a logic circuit which outputs a high level when all the plurality of internal input signals have a high level.

7. The semiconductor memory system according to claim 5, wherein the memory device has two ranks and the selection circuit unit comprises:
a first internal signal generation part for receiving a first internal chip select signal for selecting a first rank of the two ranks and the output signal of the decoding circuit unit and generating a first active signal for driving at least one of the banks in the first rank; and
a second internal signal generation part for receiving a second internal chip select signal for selecting a second rank of the two ranks, the rank mode signal and the output signal of the decoding circuit unit and generating a second active signal for driving at least one of the banks in the second rank.

8. The semiconductor memory system according to claim 5, wherein, depending upon a phase of the rank mode signal, the two ranks are selectively operated.

9. A semiconductor memory system comprising:
a first rank and a second rank; and
a shared circuit section shared by the first rank and the second rank to provide signals,
wherein the first and second ranks and the shared circuit section are configured as one memory device, and the first rank and the second rank are selectively driven.

10. The semiconductor memory system according to claim 9, wherein the shared circuit section comprises:
an input buffer for receiving a plurality of command signals and chip select signals for selecting the ranks to generate internal input signals and internal chip select signals; and
a command decoder for receiving the internal input signals and the internal chip select signals outputted from the input buffer and a rank mode signal to output internal active signals for driving the ranks.

11. The semiconductor memory system according to claim 9, wherein each of the first and second ranks includes a bank controller for outputting a control signal to at least one of banks of the rank in response to the internal active signal outputted from the command decoder.

12. The semiconductor memory system according to claim 11, wherein the command decoder comprises:
a decoding circuit unit for receiving the internal input signals; and
a selection circuit unit for generating internal active signals to determine a rank to be operated, in response to an output signal of the decoding circuit unit and the internal chip select signals.

13. The semiconductor memory system according to claim 12, wherein the decoding circuit unit includes a logic circuit which outputs a high level when all the plurality of internal input signals have a high level.

14. The semiconductor memory system according to claim 12, wherein the selection circuit unit comprises:
a first internal signal generation part for receiving a first internal chip select signal for selecting the first rank of the two ranks and the output signal of the decoding circuit unit to generate a first active signal for driving at least one of banks in the first rank; and
a second internal signal generation part for receiving a second internal chip select signal for selecting the second rank of the two ranks, the rank mode signal and the output signal of the decoding circuit unit to generate a second active signal for driving at least one of banks in the second rank.

15. The semiconductor memory system according to claim 10, wherein, depending upon a phase of the rank mode signal, the two ranks are selectively operated.

16. A semiconductor memory system comprising:
a memory controller;
a memory device controlled by the memory controller; and
a plurality of ranks integrated in the memory device,
wherein the plurality of ranks receive a rank mode signal and select signals from the memory controller such that selective one of the plurality of ranks is operated or the plurality of ranks are simultaneously operated.
